(19) United States
(12) Patent Application Publication
(10) Pub. No.: US 2026/0119555 A1
(43) Pub. Date: Apr. 30, 2026

(54) SYSTEM AND METHOD FOR SELECTING A CAPABILITY OF AN ARTIFICIAL INTELLIGENCE (AI) PRODUCTIVITY TOOL-ENABLABLE SOFTWARE APPLICATION VIA VECTORIZED AND NORMALIZED SYSTEM/COMPONENT CONTEXT TELEMETRY DATA

(71) Applicant: Dell Products LP, Round Rock, TX (US)

(72) Inventors: Yun-Chen Kuan, Taipei (TW); Srikanth Kondapi, Austin, TX (US); Ashutosh Singh, Austin, TX (US)

(73) Assignee: Dell Products LP, Round Rock, TX (US)

(21) Appl. No.: 18/929,992

(22) Filed: Oct. 29, 2024

(51) Int. Cl. G06F 16/33; G10L 15/26

(52) U.S. Cl. CPC G06F 16/3347; G06F 16/3344; G10L 15/26

(57) ABSTRACT

An information handling system includes a hardware processor executing code instructions of an artificial intelligence (AI) productivity tool subagent to gather system/component context telemetry data and to invoke a telemetry data-to-vectorized telemetry intent machine learning (ML) model algorithm to vectorize the system/component context telemetry data and normalize each dimension in the vectorized system/component context telemetry data to a telemetry intent value using a hardware-specific normalization factor. The hardware processor executes code instructions of a query input-to-intent ML model algorithm to generate a query intent value for received user query input and concatenate the telemetry intent value with the query intent value to produce a unified telemetry and query intent value. The hardware processor identifies a plurality of responsive capabilities of AI productivity-tool enablable software applications responsive to the user query input using the unified telemetry and query intent value as input and select at least one responsive capability intent action.

### FIELD OF THE DISCLOSURE

The present disclosure generally relates to execution of computer-readable program code instructions of an artificial intelligence (AI) productivity tool software module to identify a capability associated with the execution of an AI productivity tool-enablable software application responsive to user query inputs. The present disclosure more specifically relates systems and methods of executing computer-readable program code instructions for the AI productivity tool software module to identify and select among capabilities of one or more AI productivity tool-enablable software applications responsive to a user query input and based on vectorized and normalized system/component context telemetry data concatenated with vectorized query intent value to produce a unified telemetry and query intent vector.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workplace productivity applications or other application such as for teleconferencing, word processing, sales systems, business software, gaming applications, or the like. Further, the information handling system may include an on the box (OTB) artificial intelligence (AI) productivity tool software module employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions of an AI productivity tool software module to identify and select among a plurality of responsive capabilities of AI productivity tool-enablable software applications responsive to a user query input and adapt selection of those capabilities based on gathered, vectorized, and normalized system/component context telemetry data according to an embodiment of the present disclosure;

FIG. 2 is a graphic and block diagram illustrating an information handling system that includes computer-readable program code instructions of an AI productivity tool software module to identify and select among a plurality of responsive capabilities of AI productivity tool-enablable software applications responsive to a user query input and adapt selection of among capabilities based on gathered, vectorized, and normalized system/component context telemetry data according to another embodiment of the present disclosure;

FIG. 3 is a flow diagram showing a method executing computer readable code instructions for normalizing the system/component context telemetry data and concatenating vectorized and normalized system/component context telemetry data with a vectorized query intent value to generate unified telemetry and query intent value to similarity match with one or more responsive capability intent actions responsive to a user query input according to an embodiment of the present disclosure; and

FIG. 4 is a flow diagram showing a method executing computer readable code instructions for selecting a capability of an artificial intelligence (AI) productivity tool-enablable software application similarity matched to unified telemetry and query intent value via execution of computer-readable code instructions of an AI productivity tool software module based on according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tool software applications to optimize user productivity and performance of the information handling systems. Examples of such artificial intelligence methodologies includes chatbots to simulate conversations between the information handling system and the user. In an example embodiment of the present disclosure, an AI productivity tool software module may be used to trigger changes in firmware or hardware (e.g., changing display or power settings), software, or processes of one or more AI productivity tool-enablable software applications (e.g., send an e-mail or text message, schedule a meeting, or modify firmware or hardware via driver software). Various machine learning models may be used to support such functionality, including automatic speech recognition (ASR) models (e.g., speech-to-text machine learning (ML) model algorithms), text embedding models, and similarity search models that may work in combination with one another to identify a capability intent action that may be taken by an AI productivity tool-enablable software applications as similarity matched to a request within a received user query input according to embodiments herein. For example, an AI productivity tool software module and an operatively-coupled AI productivity tool subagent may be capable of determining a user’s intent for correlation to a capability intent action that is responsive to a user query input. The AI productivity tool software module and subagent matches a determined query intent with a capability intent known to be achievable, based on published or established capabilities by a particular of one or more AI productivity tool-enablable software applications executing at the information handling system. In some examples, once the AI productivity tool-enablable software application capable of performing the user-requested capability intent action within the user query input is identified, the AI productivity tool subagent may identify an application programming interface (API) call that, when executed, may cause the AI productivity tool-enablable software application associated with the identified capability to perform that identified, responsive capability.

As described, however, the AI productivity tool subagent identifying the AI productivity tool-enablable software application that can provide the capability intent action identified from the user query input may face limitations, particularly with vague user query inputs in providing responsive capability intent actions. For example, an intent identification software application such as an AI productivity subagent executing one or more ML model algorithms may be limited to mapping of a specifically-identified user intent action to a capability of an AI productivity tool-enablable software application used to execute that intent action. In some examples, this mapping of identified user intent actions to capabilities associated with any given AI productivity tool-enablable software application does not account for or depend on system/component context telemetry data and is left for developers to make these mapping decisions when defining or identifying available capabilities. The inability of the intent identification software application to consider this system/component context telemetry data at the intent identification software application in an information handling system environment that consistently changes creates a gap between what the user may have intended to be completed and the current system/component context telemetry data with the user query input and the responsive capability intent actions ultimately carried out. Identification of one or more best match responsive capabilities with similarity matching may benefit from further context of the information handling system such as telemetry or states to identify more accurate responsive capabilities Customization of the user-requested capability intent action for responses accounting for user operating context telemetry data and system/component context telemetry data can further increase the useability and user-satisfaction of the information handling system.

The present specification describes systems and methods of selecting a capability of an artificial intelligence (AI) productivity tool-enablable software application via execution of computer-readable code instructions of an AI productivity tool software module. An information handling system may include a hardware processor executing computer-readable program code instructions of a system component and user context discovery software application to gather system/component context telemetry data describing operating hardware, hardware modes, and hardware resource consumption. Additionally, the hardware processor executes computer-readable program code instructions of an artificial intelligence (AI) productivity tool software module to receive user query input from a user of the information handling system via an input/output device.

In embodiments of the present disclosure, the hardware processor may execute computer-readable program code instructions of an AI productivity tool subagent of the AI productivity tool software module to invoke a telemetry data-to-vectorized telemetry intent machine learning (ML) model algorithm. The system/component context telemetry data may be monitored and gathered for plural hardware components in the information handling system and each type normalized using a hardware-specific normalization factor via execution of a system component and user context discovery and normalization software application. Execution of the telemetry data-to-vectorized telemetry intent ML model algorithm normalizes gathered system/component context telemetry data with a normalization factor and generates a normalized telemetry data value vector of a multi-axis vector space from the system/component context telemetry data in an embodiment.

Execution of computer readable code instructions of an AI productivity tool subagent may receive a user query input from an input/output device and invoke a query-input-to-intent ML model algorithm to generate a vectorized query intent value for the user query input. Then execution of the AI productivity tool subagent concatenates the vectorized system/component context telemetry data with the vectorized query intent value to produce a unified telemetry and query intent value according to embodiments herein. The hardware processor may then invoke a query intent-to-capability ML model algorithm to identify one or more responsive capabilities of AI productivity-tool enablable software applications responsive to the user query input and including hardware telemetry data context via the unified telemetry and query intent value as input in a semantic similarity comparison to available capability intent values. Execution of the query intent-to-capability ML model algorithm executes the semantic similarity matching to select at least one best match responsive capability intent action based on input of the system/component context telemetry data and the user operating context telemetry data and user query input to select and execute the at least one responsive capability intent action.

In an embodiment, the hardware processor may execute code instructions of the ML model algorithm including a speech-to-text ML model algorithm to convert audio user query input received at the AI productivity tool software module from a user via a microphone into text. This may be done when the user query input is in audio form such as from a video or audio received from a camera or a microphone, respectively.

In an embodiment, a plurality of hardware drivers may be operatively coupled to the system component and user context discovery software application to gather the system/component context telemetry data and send the system/component context telemetry data to the AI productivity tool subagent for concatenation with the vectorized query intent value to produce the unified telemetry and query intent value. Additionally, or alternatively, a plurality of sensors operatively coupled to the system component and user context discovery software application to gather the system/component context telemetry data and send the system/component context telemetry data to the AI productivity tool subagent for normalization and concatenation with the vectorized query intent value to produce the unified telemetry and query intent value.

In an embodiment, the hardware processor may execute the computer-readable program code instructions of the AI productivity tool subagent of the AI productivity tool software module to invoke the telemetry data-to-vectorized telemetry intent ML model algorithm to normalize each dimension in the vectorized system/component context telemetry data using a hardware-specific normalization factor obtained from a telemetry data normalization database that includes a listing of normalizing capability intents ranges. The listing of normalizing capability intent ranges includes normalizing capability intent ranges that sets normalization factors between 0 and 1, in some embodiments. In various embodiments, while concatenating the vectorized system/component context telemetry data with the vectorized query intent value to produce the unified telemetry and query intent value, this concatenation process may further include a vertical, horizontal, or merged concatenation of the vectorized system/component context telemetry data with the vectorized query intent value. Additionally, the hardware processor executes computer readable code instructions of a query intent-to-capability matching ML algorithm to select the at least one responsive capability intent action among a plurality of responsive capability intent actions by performing a similarity comparison between the individual responsive capability intent actions and the unified telemetry and query intent value using a cosine similarity algorithm, a Euclidean/L2 distance algorithm, a dot product algorithm, or a Manhattan/L1 algorithm.

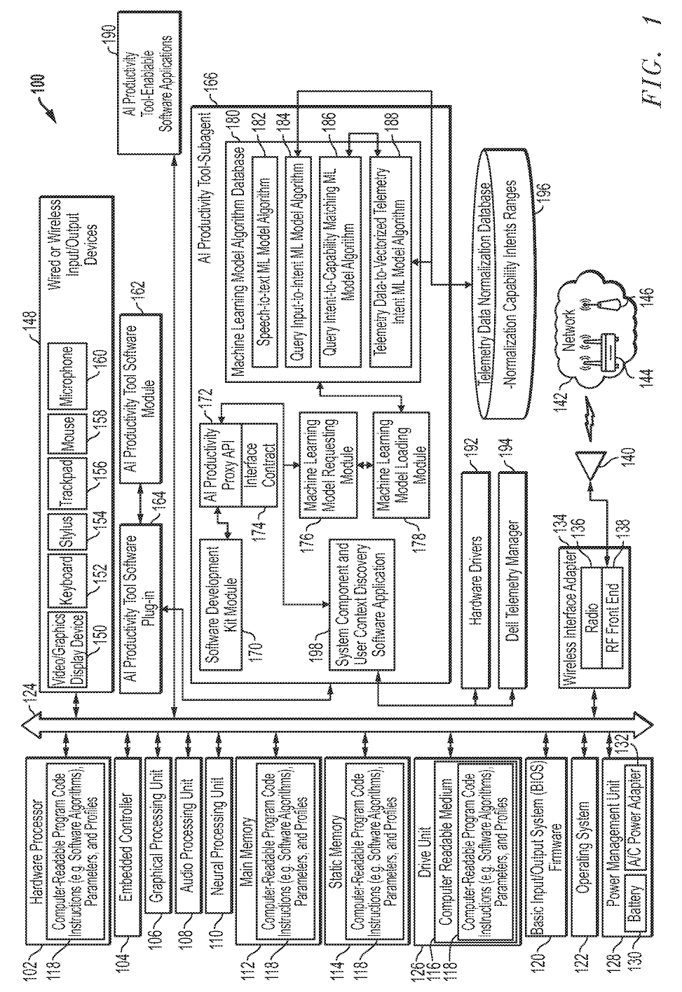

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 (e.g., central processing unit (CPU)), an embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be quickly accessible by hardware processing resources using that main memory 112. Computer-readable program code instructions stored in static memory 114, main memory 112, or drive unit 126 may involve some latency in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing instructions (e.g., software algorithms), parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various I/O devices 148 as well as between hardware processors 102, an NPU 110, an APU 108, an EC 104, a GPU 106, the operating system (OS) 122, the basic input/output system (BIOS) 120, the wireless interface adapter 134, or a radio module, among other components described herein. In an embodiment, the hardware processor 102, EC 104, GPU 106, NPU, APU, and/or others may execute one or more bus drivers in order to transmit this data between the information handling system 100 and the input/output devices 148 described herein. In an embodiment, the information handling system 100 may be in wired or wireless communication with the I/O devices 148 such as the keyboard 152, the mouse 158, the video/graphics display device 150, the stylus 154, the trackpad 156, and the microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 148, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the I/O devices 148 according to the embodiments described herein. The present specification contemplates that the I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 140 or base station 142 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end circuits 138, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by any ML model algorithm execution provider hardware processing resource such as a hardware controller or a hardware processor. For purposes of the present specification, the term ML model algorithm is meant to be understood as any machine learning or artificial intelligence (AI) algorithm that can be invoked or executed by a hardware processor to receive input data, learn from that data, and provide output to perform the processes of execution of the AI productivity tool software module 162 for receiving a user query input and identifying and executing one or more responsive capability intent actions of AI productivity tool-enablable software applications 190 selected or modified by gathered contextual telemetry data as described in embodiments herein. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions (e.g., software algorithms) parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions (e.g., software algorithms) parameters, and profiles 118 may be transmitted or received over the network 142 via the network interface device or wireless interface adapter 134.

The information handling system 100 may include a set of computer-readable program code instructions (e.g., software algorithms) parameters, and profiles 118 that may be executed to cause the computer system to perform any one or more of the methods or computer-based functions disclosed herein. For example, computer-readable program code instructions (e.g., software algorithms) parameters, and profiles 118 may be executed by a hardware processor 102, GPU 106, EC 104 or any other hardware processing resource and may include software agents, or other aspects or components used to execute the methods and systems described herein. Various software modules comprising application computer-readable program code instructions (e.g., software algorithms) parameters, and profiles 118 may be coordinated by an OS 122, and/or via an application programming interface (API). An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include computer-readable program code instructions (e.g., software algorithms) parameters, and profiles 118 in which one or more sets computer-readable program code instructions (e.g., software algorithms) parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable program code instructions (e.g., software algorithms) parameters, and profiles 118 described herein. The disk drive unit 126 or static memory 114 also contain space for data storage. Further, the computer-readable program code instructions (e.g., software algorithms) parameters, and profiles 118 may embody one or more of the methods described herein. In a particular embodiment, the computer-readable program code instructions (e.g., software algorithms) parameters, and profiles 118 may reside completely, or at least partially, within the main memory 112, the static memory 114, and/or within the disk drive 126 during execution by the hardware processor 102, EC 104, or GPU 106, NPU 110, APU 108 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a computer-readable program code instructions (e.g., software algorithms) parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, APU 108, NPU 110, a video/graphic display device 150, or other wired I/O devices 148 such as the mouse 158, the stylus 154, the keyboard 152, the microphone 160, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory such as main memory 112 or other volatile re-writable memory such as static memory 114. Additionally, the computer-readable medium can include a magneto-optical or optical medium, such as a disk or tapes or other storage device drive unit 126 to store information received via carrier wave signals such as a signal communicated over a transmission medium. Furthermore, a computer readable medium 114 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 162 and an AI productivity tool software plug-in 164 to receive user query input and provide that user query input to the AI productivity tool subagent 166. In the embodiments herein, the user query input may include audio input received from, for example, the microphone 160 or a microphone associated with the camera (e.g., a webcam). In another embodiment, the user query input may include text input by the user by the keyboard 152. In an embodiment, the execution of the computer-readable program code instructions (e.g., software algorithms) parameters, and profiles 118 of the AI productivity tool subagent 166 by the hardware processor 102 or any other hardware processing device selects among a plurality of available ML model algorithms 182, 184, 186, 188 maintained within a ML model algorithm database 180 for use with execution of a plurality of AI productivity tool-enablable software applications 190 according to another embodiment of the present disclosure. As described herein, the computer-readable program code instructions (e.g., software algorithms) parameters, and profiles 118 of the AI productivity tool software module 162 and AI productivity tool subagent 166 as well as available ML model algorithms 182, 184, 186, 188 may be executed by a hardware processor 102 or other ML model algorithm execution provider hardware processing resource on the information handling system 100 thereby allowing the processes of the AI productivity tool software module 162 to identify capabilities and respond to received user query inputs according to methods described herein to be carried out on-the-box such that a wired or wireless network connection to a network is not necessary for operation of the method. In another embodiment, some modules, databases, and/or processing resources such as ML model algorithms 182, 184, 186, 188 may be maintained on a remote server such that a wired or wireless network connection can be made with these remote servers and the method may be implemented as described herein.

The AI productivity software tool module 162 may include any artificial intelligence-based productivity tool to assist in interfacing with and execution of one or more AI productivity tool-enablable software applications 190 and receive user query inputs from a user and generate responses as responsive capability intent actions at an information handling system 100. The AI productivity tool software module 162 may be loaded on-the-box by a manufacturer in software and may include chatbot features, virtual assistant features, and other artificial intelligence features that allow a user to provide input to the information handling system 100 and, with generative artificial intelligence processing of the user query input, execute one or more responsive capabilities that include hardware operations, functions, software services such as by using one or more AI productivity tool-enablable software applications 190. Examples of some types of AI productivity tool software modules 162 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 100 may include any proprietary AI productivity tool software module 162 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool software module 162 with its AI productivity tool plug-in 164 and monitor for user input for a user query at a microphone 160, keyboard 152, or other input device for the AI productivity tool subagent 166 to engage in determining capability intent actions responsive to the user query input.

The AI productivity tool software module 164, executing on the hardware processor 102, such as a CPU, or other hardware processing resource (e.g., EC 104, GPU 106, APU 108, or NPU 110), may interface with other hardware components and with the AI productivity tool-enablable software applications 190 as well as the one or more ML model algorithms 182, 184, 186, 188 via an AI productivity tool plug-in 166. The AI productivity tool plug-in 166 may be any software or firmware that allows the AI productivity tool subagent 166 to perform processes of the AI productivity tool software module 162 to determine capability intent actions responsive to a user query input as well as telemetry data conditions for the hardware, systems, and user at the information handling system 100. Determination of responsive capability intent actions may be based on specific types of user query input (e.g., typed, spoken words, images, etc.) provided from the user, and based on current system/component context telemetry data and user operating context telemetry data as well in embodiments of the present disclosure. The AI productivity tool plug-in 164 may be used by the AI productivity tool software module 162 and AI productivity tool subagent 166 to interface with any number of AI productivity tool-enablable software applications 190 executing or executable on the information handling system 100 according to embodiments herein.

Again, the information handling system 100 also includes the AI productivity tool subagent 166 associated with the AI productivity tool software module 162. The AI productivity tool subagent 166 may be any software and/or firmware executable by the hardware processor 102 or other hardware processing resources 104, 106, 108, 110 of the information handling system 100 to interface with one or more of the plurality of the AI productivity tool-enablable software applications 190 to provide AI enabled capabilities within those AI productivity tool-enablable software applications 190 for responsive hardware, firmware, or software operations, functions, software services, or responses to user input queries. In an embodiment, the computer-readable program code instructions of the AI productivity tool-enablable software applications 190 may operate wholly “on-box” within the information handling system 100 or be subagents on-box for interfacing with remote software systems executing at remote server locations.

In an embodiment, the AI productivity tool subagent 166 may be used to direct the execution of various modules in support of one or more identified AI productivity tool operations by the AI productivity tool-enablable software applications 190 and AI productivity tool software module 162 in responding to user query inputs described herein. Additionally, the AI productivity tool subagent 166 may be provided with access to the BIOS 120 and OS 122 of the information handling system 100. Example of identified productivity tool operations include execution of code instructions of the AI productivity tool software module 162 to determine user-query intent values and telemetry intent values embedded as telemetry and query intent values, match these with generated capability intents, and to execute code instructions of one of the AI productivity tool-enablable software applications 190 to conduct commensurate capability intent actions pursuant to the user’s query input and current system/component context telemetry data and user operating context telemetry data.

In an embodiment, during operation, the hardware processor 102 or other hardware processing resource (e.g., EC 104, GPU 106, CPU, APU 108, or NPU 110) executes computer-readable program code instructions of the AI productivity tool subagent 166. The AI productivity tool subagent 166 may engage with a machine learning model requesting module 178 to have one or more ML model algorithms 182, 184, 186, 188 loaded and executed on the hardware processor in order to, initially, determine the query intent value of a user query input and telemetry intent values which are embedded as telemetry and query intent value and to correlate the telemetry and query intent value with a capability intent action to be conducted responsive to the received user query inputs. The execution of the computer-readable program code instructions of the AI productivity tool subagent 166 may call a software development kit (SDK) module 170. The SDK module 170 may include any computer-readable program code instructions that is executed by the hardware processor 102 or other hardware processing resource to request that a ML model algorithm 182, 184, 186, 188 that may be invoked to support the identification of, in an embodiment, a capability intent action based on received user query inputs from a user at the AI productivity tool software module 162.

For example, the ML model algorithms 182, 184, 186, 188 may include a query input-to-intent ML model algorithm 184 that receives the user query input, and with an embedding algorithm generates a vectorized query intent value for the user query input for later correlation with a capability intent value. In embodiments where the user query input is in audio form, the AI productivity tool subagent 166 may invoke the execution of a speech-to-text ML model algorithm 182 to initially convert this audio into text for use with the query input-to-intent ML model algorithm 184 to generate the vectorized query intent value for the user query input for later correlation with a capability intent value as described herein. Further, in embodiments herein, current system/component context telemetry data is gathered by a system component and user context discovery software application 198. The determination of the existence of or levels of the current system/component context telemetry data may also be embedded via execution of a telemetry data-to vectorized telemetry intent ML model algorithm 188 into a vectorized telemetry intent value. The vectorized telemetry intent value may then be embedded with the user query intent into a unified telemetry and query intent value generated by the query input-to-intent ML model algorithm 184 which is then used to more accurately select responsive capabilities based, in part, on the current system/component context telemetry data and user operating context telemetry data.

In an example embodiment, the information handling system 100 also includes a system component and user context discovery software application 198. Execution of the computer-readable program code instructions (e.g., software algorithms) parameters, and profiles 118 of the system component and user context discovery software application 198 gathers system/component context telemetry data describing operating hardware, hardware modes, and hardware resource consumption. In an embodiment, the system/component context telemetry data may be gathered by the system component and user context discovery software application 198 accessing any number of hardware drivers 192 and/or a Dell® telemetry manager 194. In an embodiment, the system/component context telemetry data may also be received from any other hardware or firmware device that can provide, directly or indirectly, the telemetry data described herein. For example, each of the hardware drivers 192 may be operatively coupled to a hardware device that provides system/component context telemetry data that describes the current operation of the hardware device. In a specific example embodiment, a hardware driver 192 may be associated with the PMU 128 that identifies specific voltage levels as well as a current charge state of the battery 130, battery 130 charge usage, current charging rate of the battery 130, current battery 130 temperatures (e.g., via a thermal sensor), current battery charging/use mode (e.g., balanced, high performance, power saver, battery saver, adaptive, custom, and primarily A/C modes), as well as a relative state of charge (RSOC) of the battery. In another specific example embodiment, the hardware driver 192 may include any driver software associated with any hardware processing device (e.g., 102, 104, 106, 108, 110) that describes current processing consumption and temperature of the specific hardware processing resource 102, 104, 106, 108, 110 as well as other system/component context telemetry data associated with those hardware processing resources 102, 104, 106, 108, 110. In a further example embodiment, the hardware drivers 192 may include any driver associated with a data storage device such as static memory 144 or the disk drive 126 as well as other data storage devices such as RAM. It is appreciated that any system/component context telemetry data may be accessed and gathered via the system component and user context discovery software application 198 accessing a hardware driver 192 associated with any hardware device.

Additionally, or alternatively, the system component and user context discovery software application 198 may also gather system/component context telemetry data by accessing a Dell® telemetry manager 194. The Dell® telemetry manager 194 or other telemetry monitoring service executing on the information handling system 100 may help to manage the collection of system/component context telemetry data. For example, the Dell® telemetry manager 194 may be operatively coupled to one or more sensors that monitor the current state of hardware component devices in an information handling system 100. In a specific example, the Dell® telemetry manager 194 may be operatively coupled to a temperature measuring device (e.g., a thermistor) that measures temperatures of hardware component devices within the information handling system such as the battery 130 or a hardware processing device (e.g., 102, 104, 106, 108, 110). Another sensor may include an accelerometer that may determine the position and/or movement of the information handling system 100. This system/component context telemetry data may be used as part of the input into any ML model algorithm 182, 184, 186, 188 such as the query input-to-intent ML model algorithm 184 by the AI productivity tool subagent 166 as part of selecting and identifying an appropriate responsive capability intent action responsive to the user query input received at the AI productivity tool software module 162 and including in the context of the current system/component context telemetry data and user operating context telemetry data.

In an embodiment, the ML model algorithms 182, 184, 186, 188 further includes a telemetry data-to-vectorized telemetry intent ML model algorithm 188. In an embodiment the execution of or invocation of the computer-readable program code instructions (e.g., software algorithms) parameters, and profiles 118 of the telemetry data-to-vectorized telemetry intent ML model algorithm 188 by the AI productivity tool subagent 166 may vectorize the system/component context telemetry data for particular hardware components, software systems, or user factors and normalize each dimension in the vectorized system/component context telemetry data using a hardware-specific normalization factor for each to generate a telemetry intent value, or telemetry intent vector value. This vectorization and normalization allows for each dimension of the system/component context telemetry data is embedded within the telemetry intent vector value in a multi-axis vector space includes normalized values of each of the dimensions or axes of the system/component context telemetry data for the hardware, software system, user factor or other context in embodiments herein. Because the invocation of the query-input-to-intent ML model algorithm 194 generates a vectorized query intent value for the user query input, the vectorized and normalized system/component context telemetry data generated as the telemetry intent value via invocation of the telemetry data-to-vectorized telemetry intent ML model algorithm 188 may also be concatenated with the vectorized query intent value to generate a unified telemetry and query intent value. This concatenation creates the unified telemetry and query intent value represents a link between the user query input and the current system/component context telemetry data that, together, accounts for both the user’s intent as well as customizes a resulting responsive capability intent action based on the current system/component context telemetry data.

In an embodiment, the telemetry data-to-vectorized telemetry intent ML model algorithm 188 may gain access to a telemetry data normalization database 196. The telemetry data normalization database 196, in an embodiment, may include a listing of normalization capability intent ranges that are used to create the normalized values associated with each dimension, such as for each hardware component, software system, user context, or other factor, of the system/component context telemetry data. For example, a normalization capability intent range may include a definition that the detection of a hardware processing resource consumption to be assigned a specific normalization factor that represents a maximum value to be 100% or some other normalization value (e.g., 0 to 1) such that a telemetry value of exceeding a level such as 50% may be determined as relevant in the system/component context telemetry data for generating a telemetry intent value. Additionally, or alternatively, the normalization capability intent ranges may help define that a current hardware processing resource consumption out of 100% at a level such as 50% equates to a specific dimension within the vectorized system/component context telemetry data and, thus, corresponds to a telemetry intent vector value for use with the unified telemetry and query intent value. This may be the normalization dimension within the unified telemetry and query intent value used as input to the query intent-to-capability matching ML model algorithm 186 to further identify a responsive capability as described herein.

In an example embodiment, the unified telemetry and query intent value may be used as input to the query intent-to-capability matching ML model algorithm 186. The query intent-to-capability matching ML model algorithm 186 receives the unified telemetry and query intent value from the execution of the query input-to-intent ML model algorithm 184 and telemetry data-to-vectorized telemetry intent ML model algorithm 188 as input and then matches the unified telemetry and query intent value to a vectorized capability intent value associated with the AI productivity tool-enablable software application 190. In an embodiment, this may be done via a similarity correlation algorithm for lexical or semantic matching to identify a responsive capability that can serve as the capability intent action responsive to a user query input with further context of the system/component context telemetry data gathered by the system component and user context discovery software application 198. In embodiments of the present disclosure, the capabilities may include those capabilities associated with any given AI productivity tool-enablable software application 190.

During operation, the selected ML model algorithms 182, 184, 186, 188 for a similar or common identified AI productivity-tool operation type may satisfy an interface contract 174 requested by the AI productivity tool subagent 166 such that the unified telemetry and query intent value from the user query inputs and system/component context telemetry data may be interpreted and an available capability associated with one of the plurality of AI productivity tool-enablable software applications 190 as the capability intent action can be matched to the user’s query input. The interface contract 174 described herein defines the requirements that selected ML model algorithms 182, 184, 186, 188 are to have in order to be able receive a specific type of input from the AI productivity tool software module 162, the AI productivity tool subagent 166, or any AI productivity tool-enablable software application 190 and to provide a specific type of output to the AI productivity tool subagent 166, the AI productivity tool software module 162, and/or AI productivity tool-enablable software applications 190. In an embodiment, the interface contract 174 is generated by an AI productivity proxy API 172 invoked by the SDK module 170 in order to identify the similar or common productivity-tool operation type ML model algorithms 182, 184, 186, 188 that provides the appropriate output to the AI productivity tool subagent 168.

In an embodiment, the query intent-to-capability matching ML model algorithm 188 may provide output describing a plurality of responsive capabilities of AI productivity-tool enablable software applications 190 responsive to the user query input using the unified telemetry and query intent value as input. This is done to select, in an embodiment, at least one responsive capability intent action based on input of the system/component context telemetry data and the user operating context telemetry data to select and execute the at least one responsive capability intent action to the user query input. In an embodiment, when selecting the at least one responsive capability intent action among a plurality of responsive capability intent actions, the query intent-to-capability ML model algorithm 286 may perform a similarity comparison between the individually identified responsive capability intent actions using a cosine similarity algorithm, a Euclidean/L2 distance algorithm, a dot product algorithm, or a Manhattan/L1 algorithm. This allows for the query intent-to-capability ML model algorithm 286 to select the best capability to execute to perform the responsive capability intent action that best fits the user query input with the current system/component context telemetry data.

The systems and methods described herein allows the AI productivity tool software module 162 and AI productivity tool subagent 166 to select among plural capabilities as well as fine tune any selected responsive capabilities based on the system/component context telemetry data indicating current operating status of the information handling system 100. This allows the user to execute software applications via the AI productivity tool software module 162 at the information handling system 100 such that the information handling system 100 may complete responsive capability intent actions in a manner that considers the system abilities or current status or requirements of the system to achieve the responsive result. Additionally, the user is not required to provide specific details in their user query input in order to customize the capabilities of the AI productivity tool-enablable software applications 190 and other AI productivity tool software modules because the system/component context telemetry data provides context is used to infer specific modifications to settings and operating parameters of the information handling system 100 via selection of a more context-accurate responsive capability. Thus, the AI productivity tool subagent 166 invoking the telemetry data-to-vectorized telemetry intent ML model algorithm 188 implements the system/component context telemetry data automatically in order to customize the responsive capability intent action even if the user query input is the same or generically worded in some embodiments.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

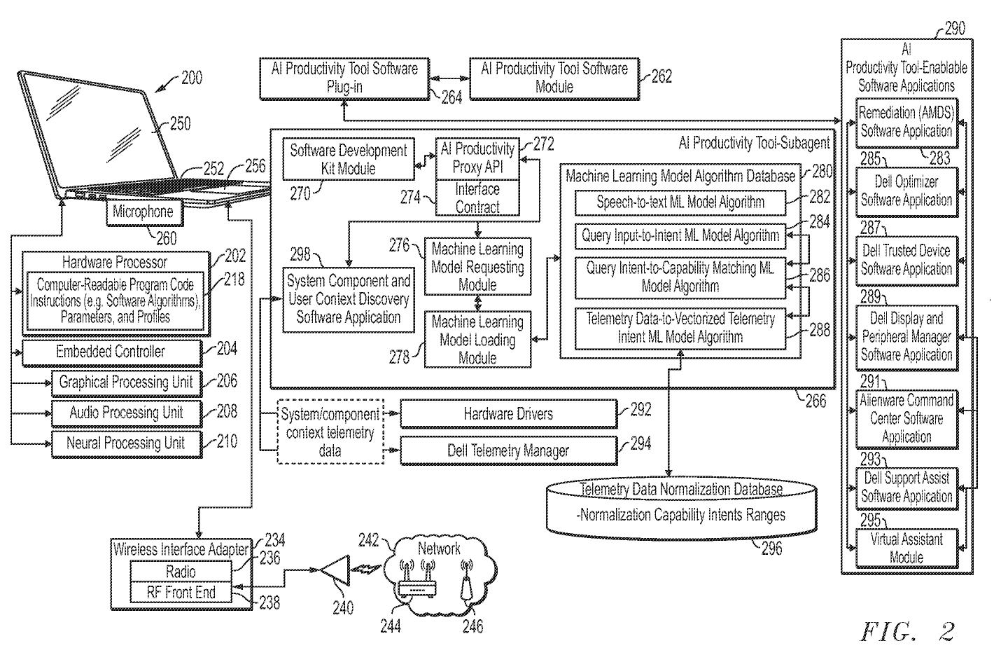

FIG. 2 is a graphic and block diagram illustrating an information handling system 200 that includes computer-readable program code instructions of an AI productivity tool software module 262 to identify and select among a plurality of responsive capabilities of AI productivity tool-enablable software applications responsive to a user query input and based on gathered system/component context telemetry data according to another embodiment of the present disclosure. As described herein, the information handling system 200 in FIG. 2 is shown as a laptop-type information handling system 200. The information handling system 200 may include a video display device 250 to provide output to the user as well as a keyboard 252, a touchpad 256, and microphone 260 for the user to provide input to the information handling system 200.

The information handling system 200 includes an AI productivity tool software module 262 and an AI productivity tool software plug-in 264 to receive user query input and provide that user query input to the AI productivity tool subagent 266. In a particular example, the user may provide the user query input of “optimize my system performance.” This may be in response to the user determining that the information handling system 200 is running a bit slow or glitchy, and the user has input this user query input in an attempt to fix this issue. This user query input may result in correlation to certain responsive capabilities in some cases that may or may not address the user query input, but system/component context telemetry data may be used in embodiments of the present disclosure to further tailor the selection of a responsive capability intent action or actions based on the detected telemetry which may indicate more particular issues to be addressed or modified. In the embodiments herein, the user query input may include audio input received from, for example, the microphone 260 or a microphone associated with the camera (e.g., a webcam). In another embodiment, the user query input may include text input by the user by the keyboard 252.

In an embodiment, the execution of the computer-readable program code instructions (e.g., software algorithms) parameters, and profiles 218 of the AI productivity tool subagent 266 by the hardware processor 202 or any other hardware processing device selects among a plurality of available ML model algorithms 282, 284, 286, 288 maintained within a ML model algorithm database 280 for use with execution of a plurality of AI productivity tool-enablable software applications 290 according to an embodiment of the present disclosure in order to address this user query input of “optimize my system performance.” As described herein, the computer-readable program code instructions (e.g., software algorithms) parameters, and profiles 218 of the AI productivity tool software module 262 and AI productivity tool subagent 266 as well as available ML model algorithms 282, 284, 286, 288 may be executed by a hardware processor 202 or other hardware processing resource on the information handling system 200 thereby allowing the processes of the AI productivity tool software module 262 to identify capabilities and respond to received user query input (e.g., “optimize my system performance”) with system/component context telemetry data according to methods described herein to be carried out on-the-box. In another embodiment, some modules, databases, and/or processing resources such as ML model algorithms 282, 284, 286, 288 may be maintained on a remote server such that a wired or wireless network connection can be made with these remote servers and some or all of the methods may be implemented as described herein.

The AI productivity software tool module 262 may include any artificial intelligence-based productivity tool to assist in interfacing with and execution of one or more AI productivity tool-enablable software applications 290 and receive user query inputs from a user, determine system/component context telemetry data, and generate responses as responsive capability intent actions at an information handling system 200. The AI productivity tool software module 262 may be loaded on-the-box by a manufacturer in software and may include chatbot features, virtual assistant features, and other artificial intelligence features that allow a user to provide input to the information handling system 200 and, with generative artificial intelligence processing of the user query input and system/component context telemetry data, execute one or more responsive capabilities that include hardware operations, functions, software services such as by using one or more AI productivity tool-enablable software applications 290. Examples of some types of AI productivity tool software modules 262 may include Cortana ® by Microsoft ®, Copilot ® by Microsoft ®, Siri ® by Apple ® Inc., Gemini ® by Google AI®, ChatGPT ® by OpenAI ®, and Amazon Alexa ® by Amazon ®, among others. It is appreciated that the information handling system 200 may include any proprietary AI productivity tool software module 262 installed by an information handling system 200 manufacturer and used to interface with the information handling system 200 and the operations thereon. In various embodiments, the hardware processor 202 or other alternative hardware processing resources of the information handling system 200 may execute computer-readable program code instructions of the AI productivity tool software module 262 with its AI productivity tool plug-in 264 and monitor for user input for this user query input (e.g., the “optimize my system performance” user query input) at the microphone 260, the keyboard 252, or other input device for the AI productivity tool subagent 266 to engage in determining capability intent actions responsive to the user query input as well as gather and address system/component context telemetry data.

The AI productivity tool software module 264, executing on the hardware processor 202, such as a CPU, or other hardware processing resource (e.g., EC 204, GPU 206, APU 208, or NPU 210), may interface with other hardware components and with the AI productivity tool-enablable software applications 290 as well as the one or more ML model algorithms 282, 284, 286, 288 via an AI productivity tool plug-in 266. The AI productivity tool plug-in 266 may be any software or firmware that allows the AI productivity tool subagent 266 to perform processes of the AI productivity tool software module 262 to determine capability intent actions responsive to a user query input at the information handling system 200 based on specific types of user query input (e.g., typed, spoken words, images, etc.) provided from the user and based on current system/component context telemetry data and user operating context telemetry data in embodiments of the present disclosure. The AI productivity tool plug-in 264 may be used by the AI productivity tool software module 262 and AI productivity tool subagent 266 to interface with any number of AI productivity tool-enablable software applications 290 executing or executable on the information handling system 200 according to embodiments herein.

Again, the information handling system 200 also includes the AI productivity tool subagent 266 associated with the AI productivity tool software module 262. The AI productivity tool subagent 266 may be any software and/or firmware executable by the hardware processor 202 or other ML model algorithm execution provider hardware processing resources 204, 206, 208, 210 of the information handling system 200 to interface with one or more of the plurality of the AI productivity tool-enablable software applications 290 to provide AI enabled capabilities within those AI productivity tool-enablable software applications 290 for responsive hardware, firmware, or software operations, functions, software services, or responses to user input queries (e.g., “optimize my system performance”) under the conditions of current system/component context telemetry data. In an embodiment, the computer-readable program code instructions of the AI productivity tool-enablable software applications 290 may operate wholly “on-box” within the information handling system 200 or be subagents on-box for interfacing with remote software systems executing at remote server locations. In an embodiment, the AI productivity tool subagent 266 may be used to direct the execution of various modules in support of one or more identified productivity tool operations by the AI productivity tool-enablable software applications 290 and AI productivity tool software module 262 in responding to user query inputs described herein. Additionally, the AI productivity tool subagent 266 may be provided with access to the BIOS and OS of the information handling system 200. Example of identified productivity tool operations include execution of code instructions of the AI productivity tool software module 262 to determine user-query intent values, determine telemetry intent values, embed telemetry and query intent values for each user query input, and match these with generated capability intents. Further, the hardware processor executes code instructions of one of the AI productivity tool-enablable software applications 290 to conduct responsive capability intent actions pursuant to the user query input of “optimize my system performance” and under the conditions of the current system/component context telemetry data.

In an embodiment, the AI productivity tool subagent 266 may engage with a machine learning model requesting module 278 to have one or more ML model algorithms 282, 284, 286, 288 loaded and executed on the hardware processor in order to, initially, determine the query intent value of a user query input and determine the telemetry intent value from current system/component context telemetry data at the time the user query input is received. Further, the one or more ML model algorithms 282, 284, 286 and 288 may concatenate the query intent value and telemetry intent value to a telemetry and query intent value and correlate it with a capability intent action to be conducted responsive to the received user query inputs and current system/component context telemetry data. The execution of the computer-readable program code instructions of the AI productivity tool subagent 266 may call a software development kit (SDK) module 270. The SDK module 270 may include any computer-readable program code instructions that is executed by the hardware processor 202 or other hardware processing resource to request that a ML model algorithm 282, 284, 286, 288 that may be invoked to support the identification of, in an embodiment, a capability intent action based on the received user query input of “optimize my system performance” from a user at the AI productivity tool software module 262 and current system/component context telemetry data.

During operation, the selected ML model algorithms 282, 284, 286, 288 for a similar or common identified AI productivity-tool operation type may satisfy an interface contract 274 requested by the AI productivity tool subagent 266 such that the query intent value from the user query inputs and telemetry intent value for the system/component context telemetry data may be interpreted or embedded and an available capability associated with one of the plurality of AI productivity tool-enablable software applications 290 as the capability intent action can be matched to the user’s query input and system/component context telemetry data. The interface contract 274 described herein defines the requirements that selected ML model algorithms 282, 284, 286, 288 are to have in order to be able receive a specific type of input from the AI productivity tool software module 262, the AI productivity tool subagent 266, or any AI productivity tool-enablable software application 290 and to provide a specific type of output to the AI productivity tool subagent 266, the AI productivity tool software module 262, and/or AI productivity tool-enablable software applications 290. In an embodiment, the interface contract 274 is generated by an AI productivity proxy API 272 invoked by the SDK module 270 in order to identify the similar or common productivity-tool operation type ML model algorithms 282, 284, 286, 288 that provides the appropriate output to the AI productivity tool subagent 268.

For example, the ML model algorithms 282, 284, 286, 288 may include a query input-to-intent ML model algorithm 284 that receives the user query input, and with an embedding algorithm generates a vectorized query intent value for the user query input of “optimize my system performance” for later use in correlating this user query input with a capability intent value. In embodiments where the user query input is in audio form, the AI productivity tool subagent 266 may initially invoke the execution of a speech-to-text ML model algorithm 282 used to convert this audio into text for use with the query input-to-intent ML model algorithm 284 to generate the vectorized query intent value for the user query input for later use in correlating with a capability intent value as described herein.

Additionally in the embodiments herein, current system/component context telemetry data is gathered and determination of the existence of or levels of the current system/component context telemetry data is also embedded in a telemetry intent value by execution of the telemetry data to vectorized telemetry intent ML model algorithm 288. With the query intent value and the telemetry intent value, the query input-to-intent ML model algorithm 284 may concatenate them into a telemetry and query intent value that is used to select responsive capabilities based, in part, on the current system/component context telemetry data and user operating context telemetry data to respond to the user query input. For example, if the system/component context telemetry data indicates that CPU utilization is at 80% in an embodiment, the embedded telemetry and query intent value may represent a vectorized semantic meaning relating to “optimize my system performance when CPU utilization is at 80%” which potentially will have a semantic similarity match to a different capability than just the user query input for “optimize my system.” The system/component context telemetry data may actually be a value of processing time or cycles normalized to a maximum processing time or cycle rate in an embodiment held as 100%. In other embodiments, plural hardware processors may be available, and system/component context telemetry data may be a value of processor utilization used across plural hardware processors normalized to 100% of capacity across those plural hardware processors. Normalization of the system/component context telemetry data is similarly applied relative to maximum capacity or speed of hardware components, minimum response times or the like for hardware components, software systems, or the like.

To accomplish this, the information handling system 200 also includes a system component and user context discovery software application 298. Execution of the computer-readable program code instructions (e.g., software algorithms) parameters, and profiles 218 of the system component and user context discovery software application 298 gathers system/component context telemetry data describing operating hardware, hardware modes, hardware resource consumption, hardware speed or response times, or similar benchmark metrics of hardware component operation. In an embodiment, the system/component context telemetry data may be gathered by the system component and user context discovery software application 298 accessing any number of hardware drivers 292 and/or a Dell® telemetry manager 294. In an embodiment, the system/component context telemetry data may also be received from any other hardware or firmware device that can provide, directly or indirectly, the telemetry data described herein. For example, each of the hardware drivers 292 may be operatively coupled to a hardware device that provides system/component context telemetry data that describes the current operation of the hardware device. In a specific example embodiment, a hardware driver 292 may be associated with the PMU 228 that identifies specific voltage levels as well as a current charge state of the battery 230, battery 230 charge usage, current charging rate of the battery 230, current battery 230 temperatures (e.g., via a thermal sensor), current battery charging/use mode (e.g., balanced, high performance, power saver, battery saver, adaptive, custom, and primarily A/C modes), as well as a relative state of charge (RSOC) of the battery. In another specific example embodiment, the hardware driver 292 may include any driver software associated with any hardware processing device (e.g., 202, 204, 206, 208, 210) that describes current processing consumption and temperature of the specific hardware processing resource 202, 204, 206, 208, 210 as well as other system/component context telemetry data associated with those hardware processing resources 202, 204, 206, 208, 210. In a further example embodiment, the hardware drivers 292 may include any driver associated with a data storage device such as static memory 244 or the disk drive 226 as well as other data storage devices such as RAM for gathering memory capacity, bad data sectors, rewrites, or similar system/component context telemetry data. It is appreciated that any system/component context telemetry data may be accessed and gathered via the system component and user context discovery software application 298 accessing a hardware driver 292 associated with any hardware device.

Additionally, or alternatively, the system component and user context discovery software application 298 may also gather system/component context telemetry data by accessing a Dell® telemetry manager 294. The Dell® telemetry manager 294 or other telemetry monitoring service executing on the information handling system 200 may help to manage the collection of system/component context telemetry data. For example, the Dell® telemetry manager 294 may be operatively coupled with one or more sensors that monitor the current state of hardware component devices in an information handling system 200. In a specific example, the Dell® telemetry manager 294 may be operatively coupled to a temperature measuring device (e.g., a thermistor) that measures temperatures of hardware component devices within the information handling system such as the battery 230 or a hardware processing device (e.g., 202, 204, 206, 208, 210). Another sensor may include an accelerometer that may determine the position and/or movement of the information handling system 200. This system/component context telemetry data may be used as part of the input into any ML model algorithm 282, 284, 286, 288 and, in the context of the present example embodiment, for the unified telemetry and query intent value. This unified telemetry and query intent value is input to the query intent-to-capability matching ML model algorithm 286 by the AI productivity tool subagent 266 as part of selecting and identifying an appropriate responsive capability intent action responsive to the user query input (e.g., “optimize my system performance”) received at the AI productivity tool software module 262 including system/component context telemetry data (e.g., hardware component utilization, consumption, or other is xx%).

In an embodiment, the ML model algorithms 282, 284, 286, 288 further includes a telemetry data-to-vectorized telemetry intent ML model algorithm 288. In an embodiment the execution of or invocation of the computer-readable program code instructions (e.g., software algorithms) parameters, and profiles 218 of the telemetry data-to-vectorized telemetry intent ML model algorithm 288 by the AI productivity tool subagent 266 may vectorize the system/component context telemetry data and normalize each dimension in the vectorized system/component context telemetry data using a hardware-specific normalization factor. This vectorization and normalization allows for each dimension of the system/component context telemetry data to be represented as a telemetry intent vector value that includes normalized values of each of the dimensions of the system/component context telemetry data. Because the invocation of the query-input-to-intent ML model algorithm 284 generates a vectorized query intent value for the user query input, the vectorized and normalized system/component context telemetry data of the telemetry intent value may also be concatenated with the vectorized query intent value via invocation of the query input-to-intent ML model algorithm 284 to produce a unified telemetry and query intent value. This concatenation creates the unified telemetry and query intent value that represents a link between the user query input of “optimize my system performance” and the current system/component context telemetry data that accounts for current operating conditions present at the information handling system 200 at the time of a user query input. Together, the concatenation of the vectorized query intent value and the telemetry intent value in the unified telemetry and query intent value accounts for both the user’s intent as well as customizes similarity matching to a resulting responsive capability intent action based on the current system/component context telemetry data.

In order to normalize each of the dimensions of the system/component context telemetry data, the telemetry data-to-vectorized telemetry intent ML model algorithm 288 may gain access to a telemetry data normalization database 296 in an embodiment. The telemetry data normalization database 296, in an embodiment, may include a listing of normalization capability intent ranges that are used to create the normalized values associated with each dimension of the system/component context telemetry data. For example, a normalization capability intent range may include a definition that the detection of a hardware processing resource consumption exceeding 50% is to be assigned a specific normalization factor out of 100% for a maximum hardware processing resource for one or more hardware processors. Additionally, or alternatively, the normalization capability intent ranges may help define that a current hardware processing resource consumption of 50% equates to a specific dimension within the vectorized system/component context telemetry data and, thus, the unified telemetry and query intent value. This may be the normalization dimension within the unified telemetry and query intent value used as input to the query intent-to-capability matching ML model algorithm 286 as described herein.

In a further example, the system/component context telemetry data may indicate that the battery charge level is at 15% or higher, for example better correlating to a responsive capability to change the user-selectable thermal tables (USTT) to be changed to “ultraperformance” is acceptable, and which is to now be indicated as one of the dimensions represented in the vectorized and normalized system/component context telemetry data in a telemetry intent value. Still further, in an example embodiment, the system/component context telemetry data may indicate that a detected temperature of a hardware processing resource or the battery has exceeded a threshold temperature but has not reached a normalized maximum temperature as a dimension represented in the vectorized telemetry intent value. In this example, the normalization capability intent ranges may dictate that a dimension of the vectorized and normalized system/component context telemetry data described for the detected temperature above the threshold temperature percentage of a maximum temperature in a unified telemetry and query intent value more similarly correlates to an capability such that the USTT is to operate at a “warm” setting and to adjust fan speed accordingly.

In yet another example, the system/component context telemetry data may have indicated that usage of the RAM has exceeded 95%. This system/component context telemetry data may be referenced with the normalization capability intent ranges stored on the telemetry data normalization database 296 and, if that RAM usage has exceeded a threshold, this telemetry intent value better correlates to a responsive capability for the RAM or portions of the RAM to be cleared for use by other processing tasks. Thus, in the embodiments described herein, the system/component context telemetry data may be referenced with normalization capability intent ranges maintained on the telemetry data normalization database 296 and reflected as individual dimensions within the vectorized and normalized system/component context telemetry data for a telemetry intent value. This telemetry intent value is concatenated with the vectorized query intent value as described herein to form a unified telemetry and query intent value which may be semantically or lexically correlated better with responsive capabilities of AI productivity tool-enablable software applications 290 that address the current system/component context telemetry data when the user query input is received.

In an example embodiment, the unified telemetry and query intent value resulting from the concatenation of the vectorized query intent value and the vectorized and normalized system/component context telemetry data in the telemetry intent value may be used as input to the query intent-to-capability matching ML model algorithm 286. The query intent-to-capability matching ML model algorithm 286 receives the unified telemetry and query intent value from the execution of the query input-to-intent ML model algorithm 284 and telemetry data-to-vectorized telemetry intent ML model algorithm 288 as input and then matches the unified telemetry and query intent value to a vectorized capability intent value associated with the AI productivity tool-enablable software application 290 according to embodiments herein. In an embodiment, this may be done via a similarity correlation algorithm for lexical or semantic matching to identify a responsive capability that can serve as the capability intent action responsive to a user query input and the current system/component context telemetry data gathered by the system component and user context discovery software application 298. In embodiments of the present disclosure, the capabilities may include those capabilities associated with any given AI productivity tool-enablable software application 290.

In an embodiment, the query intent-to-capability matching ML model algorithm 288 may provide output describing a plurality of responsive capabilities of AI productivity-tool enablable software applications 290 responsive to the user query input using the unified telemetry and query intent value as input. In one embodiment, a best match responsive capability having a highest cosine semantic or highest lexical similarity score is selected as a responsive capability intent action. This is done to select, in an embodiment, at least one responsive capability intent action based on input of the unified telemetry and query intent value (e.g., the concatenation of the vectorized query intent value and vectorized and normalized system/component context telemetry data) to select and execute the at least one responsive capability intent action. In other embodiments, one or more best match responsive capabilities having a cosine semantic or lexical similarity scores above a threshold of statistical correlation are selected as one or more responsive capability intent actions.

In an embodiment, when selecting the at least one responsive capability intent action among a plurality of responsive capability intent actions, the query intent-to-capability ML model algorithm 286 may perform a similarity comparison between unified telemetry and query intent value and the capability intent values of available capability intent actions using a cosine similarity algorithm, a Euclidean/L2 distance algorithm, a dot product algorithm, or a Manhattan/L1 algorithm. This allows for the query intent-to-capability ML model algorithm 286 to select the best capability or capabilities to execute to perform the responsive capability intent action or actions that best fits the user query input of “optimize my system performance” under conditions of the current system/component context telemetry data.

Thus, in the example embodiment, where the user query input was “optimize my system performance,” the resulting capability intent actions may cause the Dell® Optimizer ® software application to reduce RAM storage consumption, overclock the hardware processor, switch to or share processing resources with another processor (e.g., EC 204, GPU 206, APU 208, NPU 210), and speed up the rotations of the cooling fan in the information handling system 200 depending on the user query input and the current system/component context telemetry data. It is appreciated, however, that because the current system/component context telemetry data is detected, normalized, vectorized, and used as part of the unified telemetry and query intent value, the appropriate and most beneficial capability intent action may be different at different times when the user has requested to “optimize my system performance.” However, the current operating conditions of the information handling system are addressed in the presently-described systems and methods to allow for the customization of the resulting capability intent actions based on the currently-detected system/component context telemetry data.

The systems and methods described herein, therefore, allow the AI productivity tool software module 262 and AI productivity tool subagent 266 to select among plural capabilities as well as fine tune selection of responsive capabilities based on the system/component context telemetry data indicating current operating status of the information handling system 200. This allows the user to execute software applications via the AI productivity tool software module 262 at the information handling system 200 such that the information handling system 200 may complete responsive capability intent actions in a manner that considers the system abilities. Additionally, the user is not required to provide specific details in their user query input in order to customize the capabilities of the AI productivity tool-enablable software applications 290 and other AI productivity tool software modules because the system/component context telemetry data provides context from which specific modifications to settings and operating parameters of the information handling system 200 may be inferred. Thus, the AI productivity tool subagent 266 invoking the telemetry data-to-vectorized telemetry intent ML model algorithm 288 implements the system/component context telemetry data automatically in order to customize the responsive capability intent action even if the user query input is the same or generically worded in some embodiments.

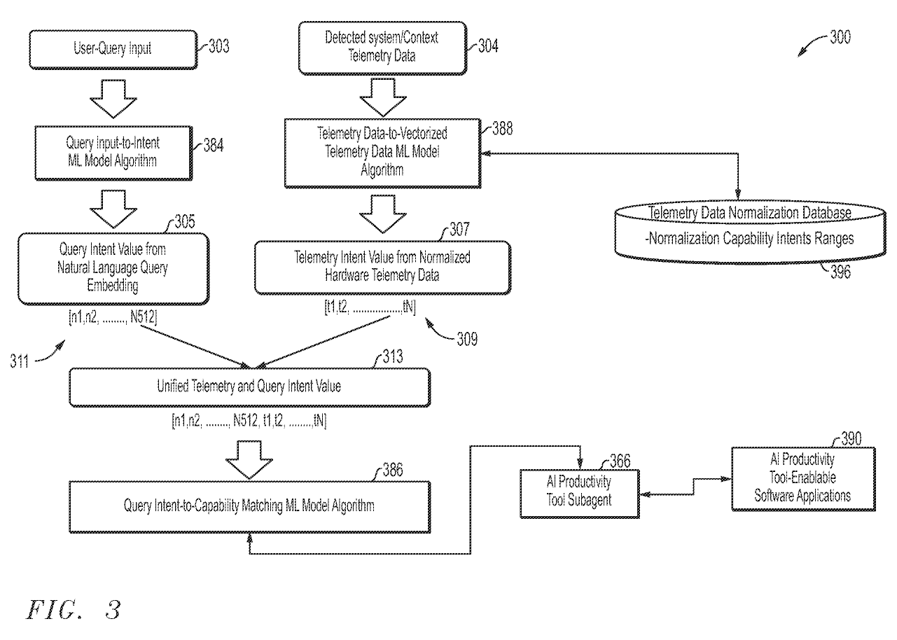

FIG. 3 is a flow diagram showing a method of executing computer readable program code instructions for normalizing the system/component context telemetry data, vectorizing the system/component context telemetry data to a telemetry intent value, and concatenating the telemetry intent value with vectorized query intent value to produce unified telemetry and query intent value to identify one or more responsive capability intent actions responsive to a user query input according to an embodiment of the present disclosure. As described herein, this process of normalizing the system/component context telemetry data 304, vectorizing the system/component context telemetry data 304 as a telemetry intent vector value 307, and concatenating the telemetry intent vector value 307 with a vectorized query intent value 306 to produce unified telemetry and query intent value 313 may be completed “on-the-box” with an information handling system such as those described in connection with FIGS. 1 and 2, for example.

The method 300 may include the user query input 303 being received by the AI productivity tool software module as described herein. Again, this user query input 303 may be received by the information handling system via txt input at a keyboard, audio input via a microphone, or image input by a user dragging and dropping or copying and pasting an image into an interface associated with the AI productivity tool software module. In an example embodiment, this user query input 303 may include any input from a user that is intended by the user to trigger changes in firmware or hardware (e.g., changing display or power settings), software, or processes of one or more capabilities of AI productivity tool-enablable software applications (e.g., send an e-mail or text message, schedule a meeting, or modify firmware or hardware via driver software), and the like. For example, the user query input 303 may include an audio or text input of “extend the lifetime of my battery” indicating that the user is worried about the ability of the battery to maintain a charge throughout the lifetime of the information handling system.

As described herein, the user query input 303 is received by the AI productivity tool subagent 366 and provided as input to a query input-to-intent ML model algorithm 384. The execution of the query input-to-intent ML model algorithm 384 receives the user query input, and with an embedding algorithm generates a vectorized query intent value 306 for the user query input for later use in correlation with a capability intent value. The output of the query input-to-intent ML model algorithm 334 includes natural language query embeddings that are vectorized into the vectorized query intent value 306. This vectorized query intent value 306 may include a number of dimensions 311 (e.g., n1, n2, . . . n512) that represent the natural langue embeddings for the natural language of the received user query input 303.

Concurrently, the AI productivity tool subagent 366 may execute the telemetry data-to-vectorized telemetry intent ML model algorithm 388. Execution of the telemetry data-to-vectorized telemetry intent ML model algorithm 388 causes the system/component context telemetry data 304 to be received as input and produces normalized hardware telemetry data embedded as a telemetry intent value 307. As described herein, execution of or invocation of the computer-readable program code instructions (e.g., software algorithms) parameters, and profiles of the telemetry data-to-vectorized telemetry intent ML model algorithm 388 by the AI productivity tool subagent may vectorize the system/component context telemetry data 304 and normalize each dimension 309 (e.g., t1, t2, . . . tN) in the vectorized system/component context telemetry data 304 using a hardware-specific normalization factor for data for each hardware type. This vectorization and normalization allows for each dimension of the system/component context telemetry data 304 to be represented as a telemetry intent vector value 307 that includes normalized values of each of the dimensions 309 (e.g., t1, t2, . . . tN) of the system/component context telemetry data 304.

Several text or other embedding algorithms may be used in various embodiments herein in order to provide a vectorized mathematical representation of semantic understanding for a user query input for a query input-to-intent ML model algorithm 384, for various types of identified current system/component context telemetry data 304 related to the user query input 303 for a telemetry data-to-vectorized telemetry intent ML model algorithm 388, or for embedding a capability described in natural language in various embodiments. For example, computer readable code instructions of the text embedding module may employ a Latent Semantic Analysis (LSA) or Latent Dirichlet allocation (LDA) which may define how close each of the observed terms in the received intervention recommendation input are to various synonyms. As another example, the text embedding module may employ a Word2Vec algorithm, which includes a neural network trained to understand which terms or phrases should be considered closer or further away from certain synonyms or antonyms. As yet another example, the text embedding module may employ a fully recurrent neural network trained to analyze the order of terms within the user query input, the current system/component context telemetry data 304, or the natural language descriptors of the capabilities for the AI productivity tool enablable software applications 390.

Because the invocation of the query-input-to-intent ML model algorithm 384 generates a vectorized query intent value 306 for the user query input 303, the vectorized and normalized system/component context telemetry data 304 of the telemetry intent value 307 is concatenated with the vectorized query intent value 306 via invocation of the query input-to- intent ML model algorithm 384 for later similarity comparison to capability intent values. This concatenation creates a unified telemetry and query intent value 313 that represents a link between the user query input of “extend the lifetime of my battery” and the current system/component context telemetry data 304 that accounts for current operating conditions present at the information handling system, such as telemetry data indicating a battery RSOC. In another example embodiment, current system/component context telemetry data 304 may indicate that a critical software application is executing such as a videoconference application. Together, the concatenation of the vectorized query intent value 306 and the vectorized telemetry intent value 307 accounts for both the user’s intent as well as customizes a resulting responsive capability intent action based on the current system/component context telemetry data 304.

As shown in FIG. 3, the method 300 also includes receiving the unified telemetry and query intent value 313 as input into the query intent-to-capability matching ML model algorithm 386. In a further example, the system/component context telemetry data 304 may indicate that the battery charge level is at 15% or lower and a video conference application is executing as one or more of the dimensions represented in the vectorized and normalized system/component context telemetry data such that the telemetry intent value 307 may more closely relate to a capability to alter the USTT values for the cooling system to conserve power. Still further, in an example embodiment, the system/component context telemetry data 304 received as input at the telemetry data-to-vectorized telemetry intent ML model algorithm 388 may have indicated that the battery level is between 15% and 30% charge as one or more of the dimensions represented in the vectorized and normalized system/component context telemetry data telemetry intent value 307 such that the telemetry intent value 307 may more closely relates to a capability to change the USTT is to a “quiet” setting reducing the speed of the fan. Additionally, the system/component context telemetry data 304 may have been received at the telemetry data-to-vectorized telemetry intent ML model algorithm 388 describing that the CPU clock rate is consistently at or above 70% as one or more of the dimensions represented in the vectorized and normalized system/component context telemetry data telemetry intent value 307 such that the telemetry intent value 309 may more closely relates to a capability to prioritize a relatively CPU-intense processes at a lower priority at the CPU.

This system/component context telemetry data 304 may be referenced with the normalization capability intent ranges stored on the telemetry data normalization database may dictate the normalization values of each dimension 309 (e.g., t1, t2, . . . tN) within the vectorized and normalized system/component context telemetry data 304 of the telemetry intent value 307. In the embodiments herein, the normalization capability intent ranges may dictate that a dimension of the vectorized and normalized system/component context telemetry data 304 of the telemetry intent value 307 is a normalize portion of maximum capacity or a designation, such as of execution of an important software application, such that the telemetry intent value 307 when concatenated into the unified telemetry and query intent value 313 better semantically or lexically matches to capabilities for changes to the USTT or to adjust fan speed or CPU prioritization of applications accordingly.

In yet another example, the system/component context telemetry data 304 may have indicated that usage of the RAM has exceeded 95%. This system/component context telemetry data 304 may be referenced with the normalization capability intent ranges stored on the telemetry data normalization database may dictate the normalization values of each dimension 309 (e.g., t1, t2, . . . tN) within the vectorized and normalized system/component context telemetry data 304 of the telemetry intent value 307. Thus, in the embodiments described herein, the system/component context telemetry data 304 may be referenced with normalization capability intent ranges maintained on the telemetry data normalization database 396 and reflected as individual dimensions 309 within the vectorized and normalized system/component context telemetry data telemetry intent value 307 for concatenation with the vectorized query intent value 313 as described herein.

After identifying one or more capability intent actions via execution of the query intent-to-capability matching ML model algorithm 386 using the unified telemetry and query intent value 313 as input and executing a cosine semantic similarity comparison or a lexical similarity comparison, the AI productivity tool subagent 366 may direct that any correlating AI productivity tool-enablable software application 390 to carry out that responsive capability intent action. Again, the present specification contemplates that multiple capability intent actions may be carried out by a plurality of AI productivity tool-enablable software applications 390 to address the user query input 303 and received system/component context telemetry data 304. This, therefore, customizes the triggered changes in firmware or hardware (e.g., changing display or power settings), software, or processes of one or more AI productivity tool-enablable software applications 390 for the user based on current operating characteristics of the information handling system from the currently detected system/component context telemetry data 304 in response to a user query input 303.

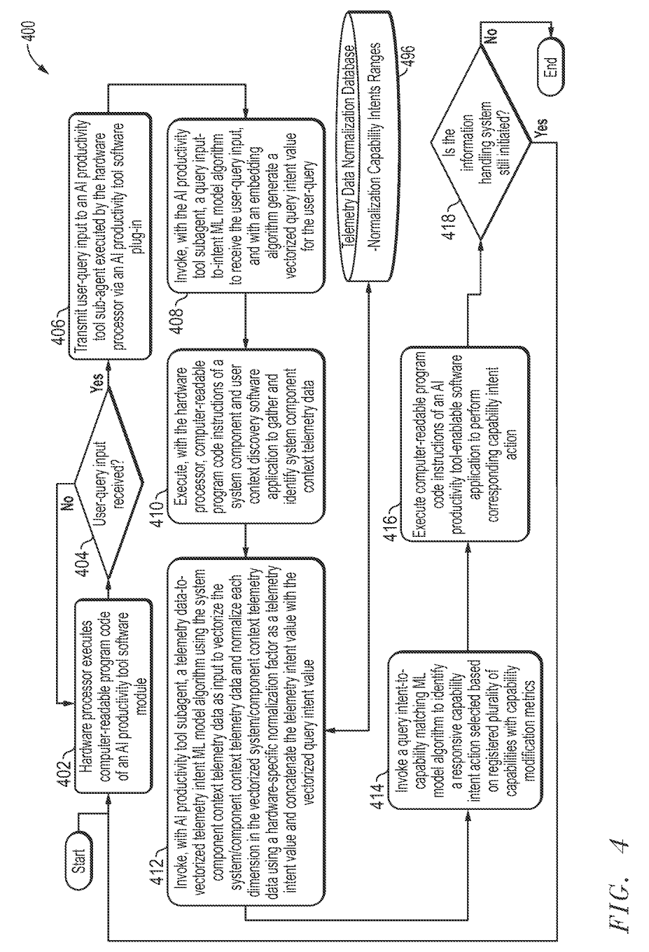

FIG. 4 is a flow diagram showing a method of executing computer readable code instructions of an artificial intelligence (AI) productivity tool software module for selecting a capability of an AI productivity tool-enablable software application based on a user query input and conditions of currently detected system/component context telemetry data according to an embodiment of the present disclosure. The method 400 described in connection with FIG. 4 may be operated on an information handling system such as an information handling system (e.g., 100, 200) described in connection with FIGS. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server and a wired or wireless network connection can be made with these remote servers and the method may be implemented as described herein.

The method 400 may include, at block 402, the hardware processor or other hardware processing device of the information handling system executes computer-readable program code instructions of an AI productivity tool software module including access to one or more AI productivity tool-enablable software applications executing on the information handling system. In an embodiment, AI productivity tool software module may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool subagent. In an embodiment, the AI productivity tool software module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for user query inputs at a microphone, keyboard, or other input device for the AI productivity tool subagent to engage in capability intent actions responsive to the user query inputs.

At block 404, the method 400 also includes determining whether any user query input has been received at the AI productivity tool software module. Where, at block 404, no user query input is received, the method 400 returns to block 402 with the AI productivity tool software module continuing to monitor for this input. Where, at block 404, the AI productivity tool software module does detect and receive user query input, the method 400 continues to block 406 with the user query input being transmitted to a capability intent identification system. The capability intent identification system includes a hardware processor executing computer readable code instructions of an AI productivity tool subagent and its modules, algorithms, and software applications being executed by the hardware processor of the information handling system. In an embodiment, the AI productivity tool subagent may orchestrate execution of some or all of the process steps of the AI productivity tool software module in identifying a user query input and identifying a responsive application capability intent action to the user query input as described embodiments herein.

In an embodiment, at block 408, the AI productivity tool subagent may invoke computer readable code instructions of a query input-to-intent ML model algorithm to receive the user query input, and with an embedding algorithm according to embodiments herein, generate a vectorized query intent value for the user query input. It is appreciated that, during operation of the AI productivity tool subagent, one or more ML model algorithms may be executed in order to embed the query intent value of the user query input in embodiments herein. The query intent value, as discussed below, is embedded with currently detected system/component context telemetry data of a telemetry intent value, and then matches a unified telemetry and query intent value to an appropriate capability intent value of an AI productivity tool-enablable software application that can perform a more accurate the responsive capability intent action in response to a user query input in view of the currently detected system/component context telemetry data in embodiments of the present disclosure.

It is appreciated that, at block 408, the selected ML model algorithms for processes of the AI productivity-tool software module, such as the query input-to-intent ML model algorithm, are selected to satisfy an interface contract requested by the AI productivity tool subagent such that the query intent value from the user query inputs may be embedded via a text embedding algorithm according to embodiments herein. Then an available capability associated with one of the plurality of AI productivity tool-enablable software applications as the capability intent action can be matched to the user’s query input according to embodiments herein. The interface contract described herein defines the requirements that selected ML model algorithms are to have in order to be able receive a specific type of input from the AI productivity tool software module, the AI productivity tool subagent, or any AI productivity tool-enablable software application and to provide a specific type of output to the AI productivity tool subagent, the AI productivity tool software module, and/or AI productivity tool-enablable software applications. In an embodiment, the interface contract is generated by an AI productivity proxy API invoked by the SDK module in order to identify the similar or common productivity-tool operation type ML model algorithms that provides the appropriate output to the AI productivity tool subagent. The query input-to-intent ML model algorithm may receive natural language text of a user query input in an example embodiment and generate a query intent vector value as an embedding as an output in an example embodiment.

At block 410, the method 400 further includes, with a hardware processor, executing computer-readable program code instructions of the system component and user context discovery software application. It is appreciated that in some embodiments, the processes associated with block 408 may be conducted prior to, concurrently with, or after the processes associated with blocks 402 through 404. In an embodiment, execution of the computer-readable program code instructions (e.g., software algorithms) parameters, and profiles of the system component and user context discovery software application gathers system/component context telemetry data describing operating hardware, hardware modes, and hardware resource consumption. In an embodiment, the system/component context telemetry data may be gathered by the system component and user context discovery software application accessing any number of hardware drivers and/or a Dell® telemetry manager. In an embodiment, the system/component context telemetry data may also be received from any other hardware or firmware device that can provide, directly or indirectly, the telemetry data described herein. For example, each of the hardware drivers may be operatively coupled to hardware device that provides system/component context telemetry data that describes the current operation of the hardware device. In a specific example embodiment, a hardware driver may be associated with the PMU that identifies specific voltage levels as well as a current charge state of the battery, battery charge usage, current charging rate of the battery, current battery temperatures (e.g., via a thermal sensor), current battery charging/use mode (e.g., balanced, high performance, power saver, battery saver, adaptive, custom, and primarily A/C modes), as well as a RSOC of the battery. In another specific example embodiment, the hardware driver may include any driver software associated with any hardware processing device that describes current processing consumption and temperature of the specific hardware processing resource as well as other system/component context telemetry data associated with those hardware processing resources. In a further example embodiment, the hardware drivers may include any driver associated with a data storage device such as static memory or the disk drive as well as other data storage devices such as RAM. It is appreciated that any system/component context telemetry data may be accessed and gathered via the system component and user context discovery software application accessing a hardware driver associated with any hardware device.

Additionally, or alternatively, the system component and user context discovery software application may also gather system/component context telemetry data by accessing a Dell® telemetry manager. The Dell® telemetry manager or other telemetry monitoring service executing on the information handling system may help to manage the collection of system/component context telemetry data. For example, the Dell® telemetry manager may be operatively coupled with one or more sensors that monitor the current state of hardware component devices in an information handling system. In a specific example, the Dell® telemetry manager may be operatively coupled to a temperature measuring device (e.g., a thermistor) that measures temperatures of hardware component devices within the information handling system such as the battery or a hardware processing device. Another sensor may include an accelerometer that may determine the position and/or movement of the information handling system. This system/component context telemetry data may be used as part of the input into any ML model algorithm and, in the context of the present example embodiment, into the telemetry data-to-vectorized telemetry intent ML model algorithm and to a query intent-to-capability matching ML model algorithm by the AI productivity tool subagent as part of selecting and identifying an appropriate responsive capability intent action responsive to the user query input (e.g., “optimize my system performance”) received at the AI productivity tool software module.

At block 412, the method 400 may include invoking, with the AI productivity tool subagent, a telemetry data-to-vectorized telemetry intent ML model algorithm. Invocation of the telemetry data-to-vectorized telemetry intent ML model algorithm vectorizes the system/component context telemetry data received from the system component and user context discovery software application and normalizes each dimension in the vectorized system/component context telemetry data using a hardware-specific normalization factor. These hardware-specific normalization factors are stored on the telemetry data normalization database 496 as normalization capability intent ranges in an embodiment. This vectorization and normalization allows for each dimension of the system/component context telemetry data to be represented as part of the embedded telemetry intent vector value that includes normalized values of each of the dimensions of the system/component context telemetry data. In an example embodiment, the telemetry data normalization database 496 may include an individual listing of normalization capability intent ranges that are used to create the normalized values associated with each dimension of the system/component context telemetry data upon embedding by an embedding algorithm to a telemetry intent value. For example, a normalization capability intent range may include a definition that the detection of a hardware processing resource consumption exceeding 50% is to be assigned a specific normalization factor relative to a maximum hardware processing resource capacity at 100% in an embodiment. Additionally, or alternatively, the normalization capability intent ranges may help define that a current hardware processing resource consumption of 50% equates to a specific dimension within the vectorized system/component context telemetry data and, thus, the unified telemetry and query intent value to a vector value (e.g, of 0.50). This may be the normalized dimension within the telemetry intent value that is later concatenated into a unified telemetry and query intent value used as input to the query intent-to-capability matching ML model algorithm 286 as described herein.

In a further example, the system/component context telemetry data may indicate that the battery charge level is at 15% or higher relative to a maximum battery charge level at 100% indicated as one of the dimensions represented in the vectorized and normalized system/component context telemetry data in the telemetry intent value which may more closely correlate with a capability to change the USTT is to be changed to “ultraperformance” in an example embodiment. Still further, in an example embodiment, the system/component context telemetry data may indicate that a detected temperature of a hardware processing resource or the battery has exceeded a threshold temperature relative to a maximum temperature level at 100% indicated as one of the dimensions represented in the vectorized and normalized system/component context telemetry data in the telemetry intent value. In this example, the normalization capability intent ranges may dictate a dimension of the vectorized and normalized system/component context telemetry data in the telemetry intent value more closely correlates to a capability for adjusting the USTT is to operate at a “cool” setting and adjust fan speed accordingly. In yet another example, the system/component context telemetry data may have indicated that usage of the RAM has exceeded 95% relative to a maximum RAM storage capacity at 100% indicated as one of the dimensions represented in the vectorized and normalized system/component context telemetry data in the telemetry intent value. This system/component context telemetry data may be referenced with the normalization capability intent ranges stored on the telemetry data normalization database 496 and, if that RAM usage has exceeded a threshold such that the telemetry intent value more closely correlates to a capability for clearing the RAM or portions of the RAM for use by other processing tasks. Thus, in the embodiments described herein, the system/component context telemetry data may be referenced with normalization capability intent ranges maintained on the telemetry data normalization database 496 and reflected as individual dimensions within the vectorized and normalized system/component context telemetry data for the telemetry intent value. This telemetry intent value may then be concatenated with the vectorized query intent value as described herein.

The method 400 further includes, at block 412, concatenating the vectorized query intent value with the telemetry intent value embedded from the vectorized and normalized system/component context telemetry data. This concatenation creates a unified telemetry and query intent value that represents a link between the user query input of “optimize my system performance” and the current system/component context telemetry data that accounts for current operating conditions present at the information handling system such as a component utilization level, speed, software or firmware execution status, or others. Together, the concatenation of the vectorized query intent value and the vectorized and normalized system/component context telemetry data accounts for both the user’s intent as well as customizes a resulting semantic or lexical correlation to a responsive capability intent action based on the current system/component context telemetry data.

At block 414, the method 400 further includes invoking a query intent-to-capability matching ML model algorithm to identify a responsive capability intent action selected based on registered plurality of capabilities of one or more AI productivity tool-enablable software applications executing on the information handling system. The query intent-to-capability matching ML model algorithm receives the unified telemetry and query intent value from the execution of the query input-to-intent ML model algorithm and telemetry data-to-vectorized telemetry intent ML model algorithm as input and then semantically or lexically matches the unified telemetry and query intent value to a vectorized capability intent value associated with the AI productivity tool-enablable software application. In an embodiment, this may be done via a similarity correlation algorithm for lexical or semantic matching to identify a responsive capability that can serve as the capability intent action responsive to a user query input and the system/component context telemetry data gathered by the system component and user context discovery software application. In embodiments of the present disclosure, the capabilities may include those capabilities associated with any given AI productivity tool-enablable software application.

Thus, at block 416, the method 400 includes executing computer-readable program code instructions of an AI productivity tool-enablable software application commensurate with the identified responsive capability intent actions at the output of the query intent-to-capability matching ML model algorithm to perform those corresponding capability intent actions. For example, where the user query input was “optimize my system performance,” the resulting capability intent actions may cause the Dell® Optimizer ® software application to reduce RAM storage consumption, overclock the hardware processor, switch to or share processing resources with another processor, speed up the rotations of the cooling fan in the information handling system or execute other adjustments to hardware, software, or firmware to address the use query input under the conditions of the current system/component context telemetry data.

At block 418, the method 400 also includes determining if the information handling system is still initiated. Where the information handling system is still initiated, the method continues to block 402 to complete those processes described herein. Where the information handling system is no longer initiated (e.g., a power button has been pushed and power has been removed from the information handling system), the method 400 may end here.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor, a memory device, and a power management unit to provide power to the hardware processor and memory device;
the hardware processor executing computer-readable program code instructions of a system component and user context discovery software application to gather system/component context telemetry data describing operating hardware, hardware modes, and hardware resource consumption at the information handling system;
the hardware processor executing computer-readable program code instructions of an artificial intelligence (AI) productivity tool software module to receive user query input from a user of the information handling system via an input/output device;
the hardware processor executing computer-readable program code instructions of a telemetry data-to-vectorized telemetry intent machine learning (ML) model algorithm to vectorize the system/component context telemetry data and normalize each dimension in the vectorized system/component context telemetry data into a telemetry intent value using a hardware-specific normalization factor;
the hardware processor executing computer-readable program code instructions of a query-input-to-intent ML model algorithm to generate a vectorized query intent value via an embedding algorithm for the user query input and to concatenate the telemetry intent value with the vectorized query intent value to produce a unified telemetry and query intent value; and
the hardware processor executing computer-readable program code instructions of a query intent-to-capability ML model algorithm to execute semantic similarity search comparison between the unified telemetry and query intent value and capability intent values for a plurality of available capabilities of AI productivity-tool enablable software applications to identify a responsive capability to execute a responsive capability intent action in response to the user query input under conditions of the system/component context telemetry data.

2. The information handling system of claim 1 further comprising:
the hardware processor executing code instructions of the ML model algorithm including a speech-to-text ML model algorithm to convert audio user query input received at the AI productivity tool software module from a user via a microphone into text.

3. The information handling system of claim 1 further comprising:
a plurality of hardware drivers operatively coupled to the system component and user context discovery software application to gather the system/component context telemetry data and send the system/component context telemetry data to the AI productivity tool software module for embedding in the telemetry intent value and concatenation with the vectorized query intent value to produce the unified telemetry and query intent value.

4. The information handling system of claim 1, further comprising:
a plurality of sensors operatively coupled to the system component and user context discovery software application to gather the system/component context telemetry data and send the system/component context telemetry data to the AI productivity tool subagent for normalization and for embedding in the telemetry intent value and concatenation with the vectorized query intent value to produce the unified telemetry and query intent value.

5. The information handling system of claim 1 further comprising:
the hardware processor executing the computer-readable program code instructions of the AI productivity tool subagent of the AI productivity tool software module to invoke the telemetry data-to-vectorized telemetry intent ML model algorithm to normalize each dimension in the system/component context telemetry data in vectors in the telemetry intent value using the hardware-specific normalization factor obtained from a telemetry data normalization database that includes a listing of normalizing capability intent ranges of hardware metrics in the system/component context telemetry data.

6. The information handling system of claim 5, wherein the listing of normalizing capability intents ranges includes normalizing capability intent ranges that sets normalization factors between 0 and 1.

7. The information handling system of claim 1, wherein concatenating the telemetry intent value with the vectorized query intent value to produce a unified telemetry and query intent value includes a vertical, horizontal, or merged concatenation of dimension values of the telemetry intent value data with dimension values of the vectorized query intent value.

8. The information handling system of claim 1, wherein selecting the responsive capability intent action among a plurality of available capability intent actions includes performing a semantic similarity comparison between available capability intent values and the unified telemetry and query intent value using a cosine similarity algorithm, a Euclidean/L2 distance algorithm, a dot product algorithm, or a Manhattan/L1 algorithm.

9. A method of selecting a capability of an artificial intelligence (AI) productivity tool-enablable software application responsive to a user query input via execution of computer-readable code instructions of an AI productivity tool software module comprising:
executing, with a hardware processor, computer-readable program code instructions of a system component and user context discovery software application to gather system/component context telemetry data describing operating hardware, hardware modes, and hardware resource consumption at an information handling system;
executing, with the hardware processor, computer-readable program code instructions of the artificial intelligence (AI) productivity tool software module to receive the user query input from a user of the information handling system via an input/output device;
executing, with the hardware processor, computer-readable program code instructions of a telemetry data-to-vectorized telemetry intent machine learning (ML) model algorithm to vectorize the system/component context telemetry data and normalize each dimension in the vectorized system/component context telemetry data using a hardware-specific normalization factor to embed the system/component context telemetry data into a telemetry intent value;
executing, with the hardware processor, computer-readable program code instructions of a query-input-to-intent ML model algorithm to generate a vectorized query intent value for the user query input and to concatenate the telemetry intent value with the vectorized query intent value to produce a unified telemetry and query intent value;
executing, with the hardware processor, computer-readable program code instructions of a query intent-to-capability ML model algorithm to identify one or more responsive capabilities of AI productivity-tool enablable software applications responsive to the user query input using the unified telemetry and query intent value as input to select at least one responsive capability intent action by a similarity comparison algorithm and based conditions of the system/component context telemetry data when the user query input is received.

10. The method of claim 9 further comprising:
executing, with the hardware processor, code instructions of an AI productivity-tool enablable software application to execute the at least one responsive capability intent action in responding to the user query input the conditions of the system/component context telemetry data when the user query input is received.

11. The method of claim 9 further comprising
gathering, via a plurality of hardware drivers operatively coupled to the system component and user context discovery software application, the system/component context telemetry data and send the system/component context telemetry data to an AI productivity tool subagent for embedding the system/component context telemetry data into the telemetry intent value via an embedding algorithm.

12. The method of claim 9 further comprising
gathering, via a plurality of sensors operatively coupled to the system component and user context discovery software application, the system/component context telemetry data and send the system/component context telemetry data to an AI productivity tool subagent for normalization and embedding the system/component context telemetry data into the telemetry intent value via an embedding algorithm.

13. The method of claim 9 further comprising
executing, with the hardware processor, the computer-readable program code instructions of the telemetry data-to-vectorized telemetry intent ML model algorithm to normalize each dimension in the vectorized system/component context telemetry data using the hardware-specific normalization factor obtained from a telemetry data normalization database that includes a listing of normalizing capability intent ranges of hardware metrics, software metrics, or sensor metrics in the system/component context telemetry data.

14. The method of claim 13, wherein the listing of normalizing capability intent ranges includes normalizing capability intents ranges that sets normalization factors between 0 and 1, and at least one hardware metric is for a capacity of a hardware component with a value of 1 relating to a maximum value for the capacity of the hardware component.

15. The method of claim 9, wherein concatenating the telemetry intent value with the vectorized query intent value to produce a unified telemetry and query intent value includes a includes a vertical, horizontal, or merged concatenation of dimension values of the telemetry intent value data with dimension values of the vectorized query intent value.

16. The method of claim 9, wherein selecting the one or more responsive capability intent actions from among a plurality of available capability intent actions includes performing a semantic similarity comparison between available capability intent values and the unified telemetry and query intent value using a cosine similarity algorithm, a Euclidean/L2 distance algorithm, a dot product algorithm, or a Manhattan/L1 algorithm.

17. An information handling system executing computer-readable code instructions of an artificial intelligence (AI) productivity tool software module for selecting a capability of an AI productivity tool-enablable software application responsive to a user query input comprising:
a hardware processor, a memory device, and a power management unit to provide power to the hardware processor and memory device;
the hardware processor executing computer-readable program code instructions of a system component and user context discovery software application to gather system/component context telemetry data describing operating hardware, hardware modes, and hardware resource consumption at an information handling system;
the hardware processor executing computer-readable program code instructions of the AI productivity tool software module to receive the user query input from a user of the information handling system via an input/output device;
the hardware processor executing computer-readable program code instructions of a telemetry data-to-vectorized telemetry intent machine learning (ML) model algorithm to vectorize the system/component context telemetry data and normalize each dimension in the vectorized system/component context telemetry data to embed a telemetry intent value using a hardware-specific normalization factor;
the hardware processor executing computer-readable program code instructions of a query-input-to-intent ML model algorithm executing an embedding algorithm to generate a vectorized query intent value from natural language text of the user query input and concatenate dimension values of the telemetry intent value data with dimension values of the vectorized query intent value;
the hardware processor executing computer-readable program code instructions of a semantic similarity comparison algorithm between the unified telemetry and query intent value and capability intent values for a plurality of available capabilities of AI productivity-tool enablable software applications to identify a plurality of responsive capability intent actions of the AI productivity-tool enablable software applications; and
the hardware processor executing computer-readable program code instructions of one or more responsive capability intent actions to respond to the user query input under conditions of the currently-detected system/component context telemetry data.

18. The information handling system of claim 17 further comprising:
the hardware processor executing code instructions of the ML model algorithm including a speech-to-text ML model algorithm to convert user query input received in audio at the AI productivity tool software module from a user via a microphone into text.

19. The information handling system of claim 17 further comprising:
a plurality of hardware drivers operatively coupled to the system component and user context discovery software application to gather the system/component context telemetry data and send the system/component context telemetry data to an AI productivity tool subagent for embedding in the telemetry intent value and concatenation with the vectorized query intent value to produce the unified telemetry and query intent value.

20. The information handling system of claim 17 further comprising:
a plurality of sensors operatively coupled to the system component and user context discovery software application to gather the system/component context telemetry data and send the system/component context telemetry data to an AI productivity tool subagent for normalization and for embedding in the telemetry intent value and concatenation with the vectorized query intent value to produce the unified telemetry and query intent value.
